(19) United States
(12) Patent Application Publication
(10) Pub. No.: US 2007/0209472 A1
(43) Pub. Date: Sep. 13, 2007

(54) Viscous damper having a sheet metal housing

(75) Inventor: Wolfgang Kiener, Berlin (DE)

Correspondence Address: CROWELL & MORING LLP;INTELLECTUAL PROPERTY GROUP, P.O. BOX 14300, WASHINGTON, DC, 20044-4300, US

(73) Assignee: Hasse & Wrede GmbH, Berlin (DE)

(21) Appl. No.: 11/712,447

(22) Filed: Mar. 1, 2007

Related U.S. Application Data
(63) Continuation of application No. PCT/EP05/09374, filed on Aug. 31, 2005.

(30) Foreign Application Priority Data
Sep. 2, 2004 (DE) 10 2004 042 942.1
Jul. 13, 2005 (DE) 10 2005 032 639.0

(51) Int. Cl. F16F 15/16

(52) U.S. Cl. 74/573.1

(57) ABSTRACT

A viscous damper having a sheet metal housing and cover for closing the housing is described. A flywheel ring is mounted in a fluid in a floating manner inside the housing, and the viscous damper includes a bearing borehole. An additional centering capability for the viscous damper is provided on the cover and/or on the housing, in the form of centering projections arranged on a common periphery. In this way, the viscous damper can be additionally or independently centered on a larger diameter than that of the bearing borehole. Other centering projections can be arranged on different peripheries.

### CROSS REFERENCE TO RELATED APPLICATIONS

This application is a continuation of PCT International Application No. PCT/EP2005/009374, filed Aug. 31, 2005, which claims priority under 35 U.S.C. § 119 to German Patent Application Nos. 10 2004 042 942.1 filed Sep. 2, 2004 and 10 2005 032 639.0 filed Jul. 13, 2005, the entire disclosures of which are herein expressly incorporated by reference.

### BACKGROUND AND SUMMARY OF THE INVENTION

The present invention relates to a viscous damper having a housing and a cover, the housing and/or the cover being manufactured, for example, from sheet metal, a moveable flywheel ring mounted floatingly, preferably in a fluid, such as a viscous fluid, being arranged within the housing and the viscous damper having a bearing bore.

Viscous dampers of the abovementioned type are known and are used for the damping of, for example, crankshafts of engines.

In this context, the viscous dampers are centered onto a corresponding shaft via their bearing bore.

The present invention provides a viscous damper of the generic type which is equipped with additional centering possibilities.

This is achieved, according to the invention, using at least two centering projections lying on a common circle circumference that are provided on the housing and/or, if appropriate, on the cover, if present.

Via these centering projections, a viscous damper can also be easily centered on a larger diameter than on that of the bearing bore, and there is the possibility of additional centering via the centering projections.

An embodiment is preferred, in which three centering projections lie on a common circle circumference.

In one exemplary embodiment, centering is possible even with two centering projections, but this is markedly improved by the arrangement of three centering projections, in which case these may be arranged uniformly so as to be angularly offset with respect to one another.

The use of more than three centering projections may be expedient in certain cases, but is not absolutely necessary.

Particularly with respect to manufacturing, it is especially simple if the centering projections are formed by cut-out, punched-out or stamped-out portions or the like.

In this case, the cut-out, punched-out or stamped-out portions or the like may be arranged so as to run both radially and tangentially.

An exemplary embodiment of the invention is illustrated in the accompanying drawings and is described in more detail below.

Other objects, advantages and novel features of the present invention will become apparent from the following detailed description of the invention when considered in conjunction with the accompanying drawings.

### BRIEF DESCRIPTION OF THE DRAWINGS

In the drawings:

FIG. 1 shows a perspective cut-away illustration of an exemplary viscous damper according to the invention;

FIG. 2 shows an enlarged illustration of the detail designated by II in FIG. 1; and

FIG. 3 shows an enlarged illustration of the detail designated by III in FIG. 1.

### DETAILED DESCRIPTION OF THE DRAWINGS

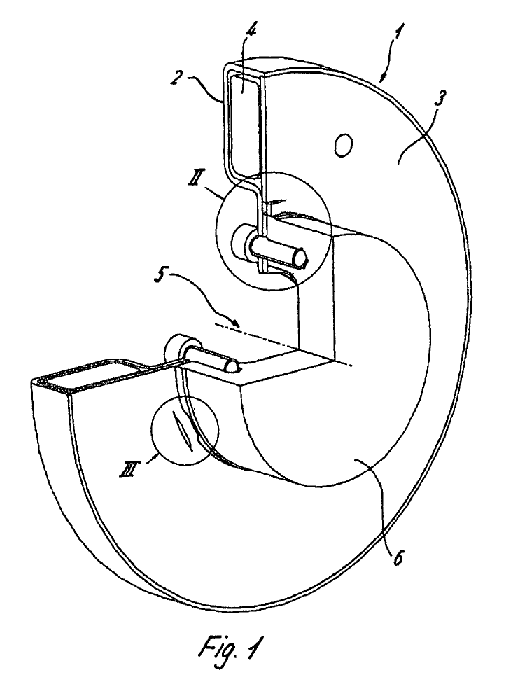

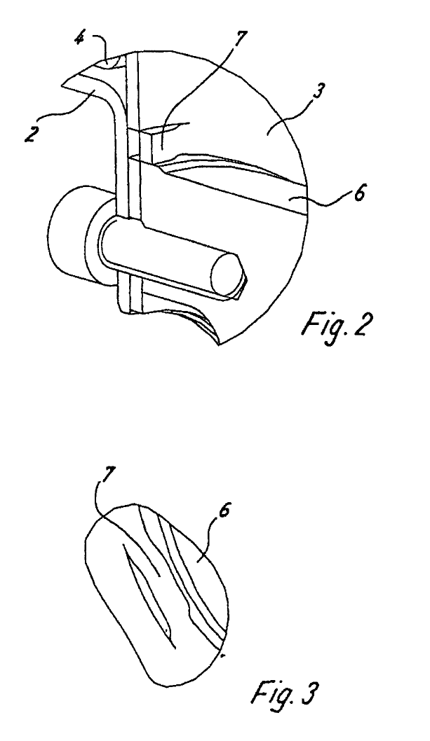

In FIG. 1, an exemplary viscous damper assembly is designated by the reference symbol 1, and consists of a housing 2, of a cover 3 closing the housing 2 and of a flywheel ring 4 which is mounted floatingly, for example in a fluid, within the housing 2.

The viscous damper 1 according to this embodiment, may be equipped with a bearing bore 5 and may be centered in the usual way via the center bore 5 on a shaft 6, which is indicated only generally.

According to the present invention, in the exemplary embodiment illustrated, the cover 3 has provided on it centering projections 7, which make it possible to center the viscous damper 1 on a larger diameter than the shaft diameter, or to allow a centering of the viscous damper 1 in addition to the centering on the shaft 6.

In this embodiment, at least two centering projections 7 are provided on the cover so as to lie on a common circle circumference. Additional centering projections 7 may, optionally, also be provided on the housing 2.

In other embodiments, it is also possible to arrange on the cover 3 or on the housing 2 centering projections 7 which lie on different circle circumferences.

In each case, three projections 7 on a common circle circumference are preferred, since this results in an extremely good ratio between the cost of producing the centering projections 7 and the centering reliability and precision.

The centering projections 7 may be formed by stamped-out or punched-out portions or the like, in a region of the cover 3 or of the housing 2. In this case, the centering projections may be provided on the cover 3 and/or on the housing 2, so as to run both radially and tangentially.

In an embodiment different from the exemplary embodiment illustrated above, it is also possible to fasten the centering projections 7 as separate components to the cover 3 or to the housing 2. In this case, it is possible to select both a releasable and an unreleasable type of connection. For example, separately manufactured centering projections 7 could be fastened by screwing them to the cover 3 and/or to the housing 2. However, the centering projections 7 could also be fastened unreleasably to the cover 3 or to the housing 2 by welding or other types of connection.

Nonetheless, it may be preferable to form the centering projections 7 on the sheet metal housing 2 and/or the sheet metal cover 3 by stamping out, punching out or other like processes, from the standpoint of overall economic criteria.

In addition to the exemplary embodiments illustrated, it is also conceivable to form on the housing 2 of the viscous damper 1 a plurality of centering projections 7, which lie on circles having different diameters.

This increases the possible application for use of a viscous damper 1 according to the invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A viscous damper comprising:
a sheet metal housing;
a cover;
a movable flywheel ring mounted floatingly in a fluid being arranged within the housing;
a bearing bore of the viscous damper; and
a centering device, wherein the centering device consists of at least two centering projections provided on at least one of the housing and the cover, the at least two centering projections lying on a common circle circumference and comprising one of cut-out, punched-out and stamped-out portions.

2. The viscous damper as claimed in claim 1, further comprising three centering projections which lie on a common circle circumference.

3. The viscous damper as claimed in claim 1, wherein the at least two centering projections are arranged on a circle circumference lying concentrically with respect to the bearing bore.

4. The viscous damper as claimed in claim 1, wherein the at least two centering projections are arranged on at least one of the cover and the housing so as to run radially or tangentially.

5. The viscous damper as claimed in claim 1, wherein the comprises a plurality of centering projections which lie on circles having different diameters.

6. The viscous damper as claimed in claim 5, wherein the centering projections are releasably connected to at least one of the cover and the housing.

7. The viscous damper as claimed in claim 5, wherein the centering projections are unreleasably connected to at least one of the cover and the housing.

8. The viscous damper as claimed in claim 4, wherein the centering projections comprise at least one of cut-out, punched-out or stamped-out portions.

9. The viscous damper as claimed in claim 6, wherein the centering projections are arranged on at least one of the cover and the housing so as to run radially or tangentially.

10. The viscous damper as claimed in claim 6, wherein the housing comprises a plurality of centering projections which lie on circles having different diameters.

11. The viscous damper as claimed in claim 1, wherein the cover is manufactured from sheet metal.

12. The viscous damper as claimed in claim 7, wherein the centering projections are arranged on at least one of the cover and the housing so as to run radially or tangentially.

13. The viscous damper as claimed in claim 7, wherein the housing comprises a plurality of centering projections which lie on circles having different diameters.

14. A viscous damper assembly, comprising:
a housing containing a fluid and defining a bearing bore;
a cover closing the housing;
a movable flywheel disposed in the fluid filled housing; and
centering projections extending from at least one of the housing and the cover, the centering projections lying on a common circle circumference.

15. The viscous damper assembly according to claim 14, further comprising additional centering projections lying on a second different common circle circumference.

16. The viscous damper assembly according to claim 14, further comprising three centering projections.

17. The viscous damper assembly according to claim 14, wherein at least one of the housing and the cover is formed of sheet metal.

18. The viscous damper assembly according to claim 14, wherein the centering projections further comprise one of cut-out portions, punched-out portions and stamped out portions.

19. The viscous damper assembly according to claim 14, wherein the centering projections are releasably attached to one of the housing and the cover.

20. The viscous damper assembly according to claim 14, wherein the centering projections extend radially or tangentially.
